(19) United States
(12) Patent Application Publication
(10) Pub. No.: US 2011/0295843 A1
(43) Pub. Date: Dec. 1, 2011

(54) DYNAMIC GENERATION OF CONTEXTUALLY AWARE PLAYLISTS

(75) Inventors: Michael I. Ingrassia, JR., San Jose, CA (US); Benjamin A. Rottler, San Francisco, CA (US)

(73) Assignee: APPLE INC., Cupertino, CA (US)

(21) Appl. No.: 12/788,095

(22) Filed: May 26, 2010

(51) Int. Cl. G06F 17/30

(52) U.S. Cl. 707/723; 707/769; 707/E17.014; 707/E17.005

(57) ABSTRACT

The embodiments described herein utilize various user-centric metrics to define and/or refine the generation of a contextually aware media playlist.

### CROSS REFERENCE TO RELATED APPLICATIONS

This patent application is related to U.S. patent application entitled “SYSTEM AND METHOD FOR PLAYLIST GENERATION BASED ON SIMILARITY DATA” by Gates et al. Having Ser. No. 12/242,735 and Attorney Docket No. 8802.010.NPUS00 (P6635US1) filed Sep. 30, 2008 which is incorporated by reference in its entirety for all purposes.

### TECHNICAL FIELD

The embodiments described herein relate generally to using personal contextual data and media similarity data to generate contextually aware media playlists aligned with a user's personal rhythms and experiences.

### BACKGROUND

A number of mechanisms have been developed to automate the generation of playlists. Some conventional automated playlist generators provide playlists of media files randomly selected from a media file collection, such as a playlist of randomly-selected songs from various artists, from a particular artist, or from a particular genre. Other conventional automated playlist generators are time-based in that they generate playlists of media files that have not been played in a while, or that include a set of media files that have been most recently played. Still other approaches rely upon frequency-based playlist generation techniques that generate playlists of media files based upon a frequency of play (i.e., either frequently or infrequently). Content-based playlist generators provide playlists of songs that sound similar, for example, according to acoustics or clarity whereas other playlist generators provide rules-based playlist generation that use rules to play top-rated songs (five-star songs). Such rules-based playlist generators can be configured to generate playlists from a combination of one or more of the above, e.g., 35% random, 35% five-star, and 30% of songs never heard. In any case, each of the above mentioned playlist generation protocols are very mechanical on how select media items are selected.

None of these conventional automated playlist generation mechanisms take into account the many human factors involved in making a playlist enjoyable and interesting. Playlists are more than just collections of media files. The juxtaposition of artists, styles, themes and mood may make the whole greater than the sum of its parts. As described above, conventional automated playlist generators typically generate playlists using simple criteria such as acoustic similarity, random selection within a genre, alphabetical by title, and so on. These simple criteria tend to result in playlists that lack the interesting juxtapositions of songs, i.e., they lack the “human element” expected and desired by listeners. As such, playlists generated by conventional automated playlist generators tend to be less appealing and interesting than those generated by knowledgeable human listeners. However, the qualities that make a playlist “interesting” to a particular user are difficult to quantify. For example, media files of digitized music may be related by musical theme, lyrical theme, artist, genre, instrumentation, rhythm, tempo, period (e.g., 60s music), energy etc. The subtleties involved are beyond what can be expected of a machine to understand using the conventional automated playlist generation techniques described above.

Therefore, a system, method, and apparatus for a more user centric playlist generation are desired.

### SUMMARY OF THE DESCRIBED EMBODIMENTS

A real time method of automatically providing a context aware playlist of media items is carried out by performing at least the following operations. Collecting data that includes user data, context data, and metadata for each of a plurality of media items that describes attributes of each of the media items. Analyzing the data by identifying a context and generating a context profile that includes a plurality of weighted media item attributes in accordance with the user data and the context data. Generating the context aware playlist using the context profile and providing the context aware playlist to a user in real time.

In one implementation, the context profile filters the media item metadata in order to identify those media items for inclusion in the context aware playlist of media items.

In another embodiment, a method is described for providing a context aware group playlist of media items. The method can include at least the following operations: identifying a group context with an activity of a group, determining group metrics comprising receiving a user data file from each of at least two members of the group identified as active participants, collecting user data at least from the active participants, forming a group profile by collating the collected user data files, generating a group playlist of media items using the group profile, and distributing the group playlist of media items to each of the at least two members of the group.

A portable media player is described. In one embodiment, the portable media player includes at least an interface for facilitating a communication channel between the portable media player and the host device and a processor arranged to receive a group playlist identifying media items for rendering in an order and manner specified by the group playlist. The host device generates the group playlist by identifying a group context for which the media items identified by the group playlist is to be used, collecting data including user data, context of use data, and media item metadata for each of a plurality of media items. The media item metadata describes media item attributes and the media items identified by the group playlist are a proper subset of the plurality of media items available to the host device. The host device further analyzes the collected data to generate a group profile corresponding to the group context where group profile includes at least a plurality of weighted media item attributes, the group profile is then used to provide the group playlist

A non-transitory computer readable medium for encoding computer software executed by a processor for providing a context aware playlist of media items is disclosed. The computer readable medium includes at least computer code for identifying a context for which the playlist of media items is to be used, computer code for collecting data, the data including user data, context of use data, and media item metadata for each of a plurality of media items, the media item metadata describing media item attributes, computer code for generating a context profile, the context profile comprising a plurality of weighted media item attributes, and computer code for using the context profile to provide the context aware playlist.

Other apparatuses, methods, features and advantages of the described embodiments will be or will become apparent to one with skill in the art upon examination of the following figures and detailed description. It is intended that all such additional apparatuses, methods, features and advantages be included within this description be within the scope of and protected by the accompanying claims.

### BRIEF DESCRIPTION OF THE DRAWINGS

The described embodiments and the advantages thereof can best be understood by reference to the following description taken in conjunction with the accompanying drawings.

FIG. 1 shows a graphical representation of personalized context-aware playlist engine in accordance with the described embodiments.

FIG. 2 illustrates a system that incorporates an embodiment of the playlist engine shown in FIG. 1.

FIG. 3 shows representation of a database in the form of data array.

FIG. 4 shows a graphical representation of context space in accordance with the described embodiments.

FIG. 5 shows a representative context space filter in accordance with the described embodiments.

FIG. 6 shows a system in communication with a cloud computing system.

FIGS. 7 and 8 show an arrangement whereby a playlist engine can provide a group playlist suitable for a social gathering such as a party.

FIG. 9 graphically illustrates a flowchart detailing a process for providing a personalized context aware playlist in accordance with the embodiments.

FIG. 10 graphically illustrates a flowchart detailing process for generating a context aware playlist in accordance with the described embodiments.

FIG. 11 shows a flowchart detailing a process in accordance with the described embodiments.

FIG. 12 illustrates a representative computing system in accordance with the described embodiments.

### DETAILED DESCRIPTION OF EXAMPLE EMBODIMENTS

In the following detailed description, numerous specific details are set forth to provide a thorough understanding of the concepts underlying the described embodiments. It will be apparent, however, to one skilled in the art that the described embodiments can be practiced without some or all of these specific details. In other instances, well known process steps have not been described in detail in order to avoid unnecessarily obscuring the underlying concepts.

A playlist can be defined as a finite sequence of media items, such as songs, which is played as a complete set. Based upon this definition there are at least three significant attributes associated with a playlist. These attributes are: 1) the individual songs contained within the playlist, 2) the order in which these songs are played and 3) the number of songs in the playlist. The individual songs in the playlist are the very reason for generating such a playlist. It is therefore essential that each song contained within the playlist satisfies the expectations of the listener. These expectations are formed based upon the listener's mood, which in turn is influenced by the environment. The order in which the songs are played provides the playlist with a sense of balance which a randomly generated playlist cannot produce. In addition to balance, an ordered playlist can provide a sense of progression such as, a playlist progressing from slow to fast or a playlist progressing from loud to soft. The number of songs in a playlist determines the time duration of the playlist.

Coherence of a playlist refers to the degree of homogeneity of the music in a playlist and the extent to which individual songs are related to each other. It does not solely depend on some similarity between any two songs, but also depends on all other songs in a playlist and the conceptual description a music listener can give to the songs involved. Coherence may be based on a similarity between songs such as the sharing of relevant attribute values. However, in relation to a context aware playlist, the coherence must also take into consideration the extent that the individual songs relate to the specific context in which they will be consumed and how important the user feels about listening to a particular song in a particular context. Therefore, in those situations where a playlist is based solely upon music items having similar attributes (based, for example, on similarity data from an aggregation of all available users), the playlist can be further processed in order to determine the extent to which the songs in the playlist align with the characteristics assigned to the particular context in which the playlist will be consumed. The further processing can take the form of filtering, or comparing, attributes of each song in the preliminary playlist with song attributes determined to be relevant to the context, or contexts, in which the songs will be played by the user.

The embodiments described herein utilize various user-centric metrics to define and/or refine the generation of a contextually aware media playlist. It should be noted that by contextually aware it is meant that the context of a media item can be considered as a factor(s) in the evaluation and generation of the media playlist. Context of use (also referred to as simply context) of the media item can be defined in part as the real world environment in which the media item (such as music) is consumed by the user. Context considered relevant to playlist generation can include location, time of operation, and velocity of the user, weather, traffic and sound where user locations and velocity can be determined by GPS. Location information can include tags based on zip code and whether the user is inside or outside (inferred by the presence or absence of a GPS signal). The times of the day can divided out into configurable parts of the day (morning, evening, etc). The velocity can abstract into a number of states such as static, walking, running and driving. If the user is driving, an RSS feed on traffic information can be used to typify the state as calm, moderate or chaotic.

In some cases, context can be situational in nature such as a party, an exercise workout or class, a romantic evening for two, or positional in nature such as traveling in the car or train (during a commute) or the location at which the music is generally played such as a beach, mountains, etc. The context of the song can also include a purpose for listening to the song, such as to relax, or concentrate, or become more alert. Environmental or physiological factors can also play a role. For example, a user's physiological state (i.e., heart rate, breathing rate), environmental conditions and other extrinsic factors can be used in developing an overall context(s) for the media item. Accordingly, the context of a media item can be as varied as the individual user's lifestyle.

A media item can be one associated with a particular context in many ways. For example, a user can expressly identify the media item as being one specifically associated with a particular context. In another case, the user can identify a song (“Barbara Ann”) or musical group (“Beach Boys”) with a particular context (“at the beach”). The same song, however, can also be associated with other contexts of use such as a mood (happy), commuting to or from work, and so on. In some cases, the association with a context can be expressed (as above) or implied based upon extrinsic factors that can be considered when developing an association with a context. For example, a media item can have associated with it metadata indicative of various extrinsic data related to the media item and how, where, and why it is consumed. Such metadata can include, for example, a location tag indicating a geographical location(s) at which a song, for example, has or is played, volume data indicating the volume at which the song is played, and so on. In this way, metadata can provide a framework for determining likely contexts of the song based in part upon these extrinsic factors. For example, if metadata indicates that a song is played during a morning commute (based upon time of day and motion considerations), then the song can be associated with a morning commute context.

Metadata can also indicate that the song is played during a bike ride (that can be inferred from positional, movement, and physiological data from the user, all of which can be incorporated into the metadata). Therefore, a single song can have associations with more than one context. However, in order to more accurately reflect how the particular song fits into the user's lifestyle, each of the contexts of use determined to be associated with a particular song can have a weighting factor associated with it. This weighting factor can, in one embodiment, vary from about zero (indicating that the song has limited, or a low degree, of relevance in the user's everyday life) to about one (indicating that the song is almost ubiquitous in the user's everyday experience).

In one embodiment, a contextually aware playlist(s) can be generated by providing a seed track to a playlist generation engine. The seed track, however, can be identified as being associated with a particular context, or contexts, of use. This context identification can be expressly provided by the requestor at the time of submission of the seed track, or it can be derived from extrinsic factors and incorporated into metadata associated with the seed track. In any case, the playlist generation engine can provide a preliminary playlist that can be filtered using a user profile to provide a context aware playlist. The user profile can include a database that correlates contexts of use and media item attributes. The user profile can also include weighting factors that can be used to more heavily weigh those attributes considered to be more relevant. Those media items successfully passing the filtering can be included in a final playlist that is forwarded to the requestor. Those media items not passing the filtering can have their metadata updated to reflect this fact.

In another embodiment, a group dynamic such as that exhibited by a group of people at a party can be used to automatically sequence and mix music played at nightclubs, parties, or any social gathering. In one case, individuals at the social gathering can provide context information from their individual playlists or other sources such as social networking sites and such.

In yet another embodiment, a different playlist would be generated based upon events outside of the immediate environment of a user. For example, a different playlist can be generated in the morning compared to the evening or different playlist would be generated in January compared with what would be generated in July or, for instance, on the month/day of a user's birthday. The profile information could include significant dates/times in the user's life such as anniversary, birthday, graduation dates, birth of children, etc. Other dates of interest can include national, religious, and other holidays that can influence the playlist generated. The calendar information can be included in the profile information associated with the user. This profile information might be taken into account when generating the playlist. Moreover, the geographical location of the user (such as a particular country, state, resort, etc.) can be used to generate a relevant playlist. For example, if a user is travelling about Europe and one day happens to be in France, the playlist generated can reflect a Gallic influence, whereas if the user then travels to Italy, the playlist can consider music with an Italian flavor.

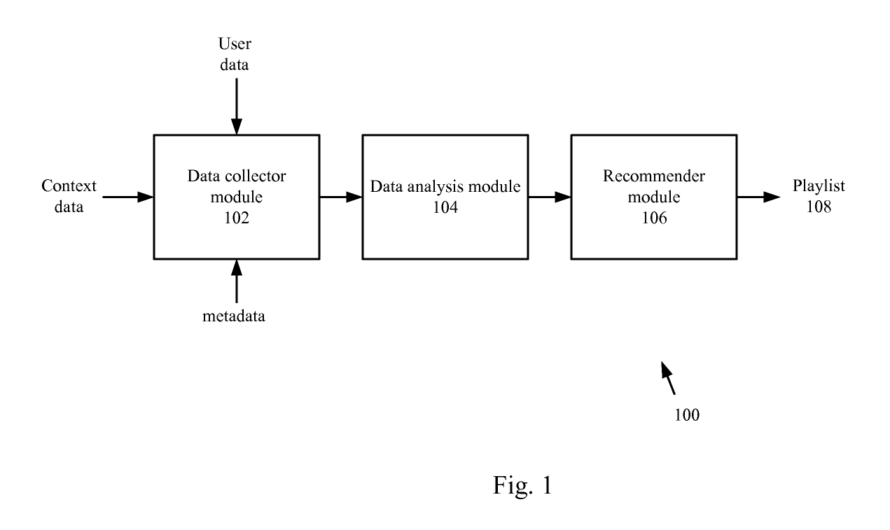

These and other embodiments are discussed below with reference to FIGS. 1-12. However, those skilled in the art will readily appreciate that the detailed description given herein with respect to these figures is for explanatory purposes only and should not be construed as limiting.

FIG. 1 shows a graphical representation of personalized context-aware playlist engine 100 in accordance with the described embodiments. Playlist engine 100 can include a number of components that can take the form of hardware or firmware or software components. Accordingly, playlist engine 100 can include at least data collector module 102, data analysis module 104, and media recommender module 106 arranged to provide context aware media playlist 108.

Data collector module 102 can be configured to collect a wide variety and types of data that can be used to personalize the context aware playlist. Data collected can include at least user data, context data, and music metadata.

Generally speaking, the foundation of any personalized service is the collection of personal, or user, data. Personalization can be achieved by explicitly requesting user ratings and/or implicitly collecting purpose related observations (which can be a preferred approach when it is desired to be as transparent to the user as possible). For example, users can rate music tracks during listening and these ratings can be directly applicable for music recommendation. As another example, if a user previously liked a track in a given situation, the same track and other similar tracks can be expected to be good recommendations when the same user and situation are encountered the next time. Respectively, if the user disliked or skipped a track, artists like it should not be recommended again. When the user just listens to music without rating it, the listening history can be collected and stored as historical data. Moreover, listening and/or skipping data on tracks, albums, and artists can help to characterize (in a non-intrusive manner) the user's musical likes and dislikes. Demographics can also be integrated into the stream of user data as can friendship graphs and other social networks that are also part of the user profile.

Context data can be collected to anchor the user's ratings and listening choices to a particular context. Context can be observed explicitly by, for example, asking the user to describe or tag the situation, and implicitly, by collecting relevant sensor readings. User-provided situation tags are again directly applicable for music recommendation, by associating all music listening choices and ratings with the coincident tags. However, in practice purely manual situation labeling may not be sufficient by itself because it would require large amounts of work from all users to describe all situations. A more practical and desirable context-aware system is one that can automatically suggest relevant tags based on location, time, activity, and other sensor values. Another important piece of context for music is the emotional state of the listener. In practical systems, the emotions or moods of the listener cannot be directly sensed, but the user can, for example, be asked. Also, it is significant that when music is listened according to its mood, information about the user's mental state can be gleaned through the user's choice of music, time of day, volume played, and so on.

In addition to the user's physical and emotional state, the user's physical location can also play a role in providing the personalized context aware playlist. Outdoors location is precisely available with a built-in GPS receiver. Where the GPS signal is not detectable, a good enough resolution can be achieved by locating the nearest cellular network cell base station. In practice, the network cell resolution ranges from hundreds of feet in dense urban areas up to tens of miles in sparsely populated areas. Indoor locations can also be more precisely detected by WLAN and Bluetooth proximity scanning (such local-area wireless networks may be useful in detecting the floor or even the room of the user). The accelerometer is sufficient to recognize movement and activity to some degree. For example, standing still, walking, running, or vehicular movement can be recognized from each other by the accelerometer signals. Further, the ambient noise spectrum can tell whenever the user is in a motor vehicle. Activity can also be observed from the phone usage data, starting with simple phone profile information (general, silent, meeting, etc.).

In addition to collecting user data and context data, media metadata can also be collected. Media metadata can contain information such as textual titles of the genres, artists, albums, tracks, lyrics, etc., as well as acoustical features of timbre, rhythm, harmony, and melody. Therefore, the music metadata can be used to associate different pieces of music, for example, with each other, and to help alleviate any lack of the rating and listening data.

Data analysis (or reason for listening) module 104 can provide music content context-aware music recommendations, i.e., suggestions of music to be listened in the user's current situation. The recommendations can be based upon given observations of the user, music content, and context features. In one embodiment, data analysis module 104 can provide a classification or regression model that can provide some estimation of rating prediction for any unrated artists or tracks based upon a given user and context. Data analysis module 104 can encompass information about all music listened to by the user in all situations (or by all users in a distributed system). Each user's music choices can be combined together to form a music preference estimate along the lines described in U.S. Patent Application entitled “SYSTEM AND METHOD FOR PLAYLIST GENERATION BASED ON SIMILARITY DATA” by Gates et al. In one embodiment, data analysis module 104 can reflect the co-occurrences of most listened artists and most visited places in a given period of time (such as the last three months) for each user. However, as this may be somewhat limiting, varying context data (such as location and time) can be collected together with the music listening data and used to build a representation of music listening situations as part of the model.

Media recommender module 106 requires taking into consideration the user's current situation and applying data analysis module 104 to predict a suitable outcome (artists, albums, movies, tracks, and so forth). In the embodiments described herein, recommender module 106 can be used to construct playlist 108 of music items using predicted ratings to generate an ordered list of tracks.

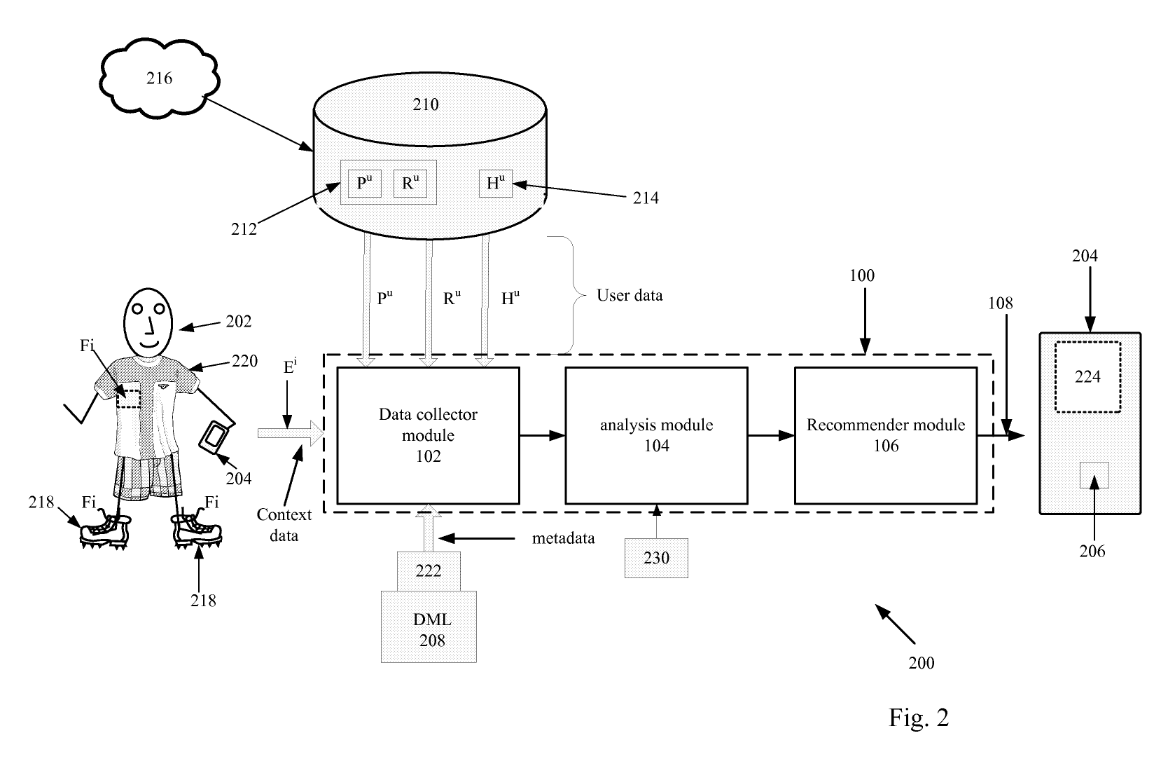

FIG. 2 illustrates system 200 that incorporates an embodiment of playlist engine 100. User 202 can use portable media player 204 to access and subsequently process media items 206 stored in digital media library (DML) 208. Media items 206 can take many forms such as digital music encoded as MP3 files, digital video encoded as MPEG4 files, or any combination thereof. For the sake of simplicity, however, for the remaining discussion unless noted otherwise, media items 206 take the form of music items such as songs {S1, S2, . . . , Sₙ} each encoded as MP3 files. Accordingly, user 202 can listen to song Sₙ using portable media player 204 arranged to retrieve and decode an MP3 file selected for play by user 202. In the described embodiment, portable media player 204 can take the form of a smart device such as an iPhone™, iPod™, and iPad™ each manufactured by Apple Inc. of Cupertino, Calif.

System 200 can access database 210 configured to store data such as profile data 212 and history data 214. Profile data 212 can include personal information (P^{u}) specific to user 202. Personal information P^{u} can include music preferences such as, for example, a user rating for each song (i.e., an indication of a degree of preference for the particular song) as well as the user's preferences in terms of musical properties, such as song genres, rhythms, tempos, lyrics, instruments, and the like. In one embodiment, music preferences can include data that is manually entered and/or edited by the user. For example, media player 204 can provide a graphical user interface (GUI) for manually editing the music preferences. In another embodiment, music preferences can be generated based on user interactions with songs as they are being played. That is, as the user interacts with songs played as a soundtrack, the music preferences can be automatically modified according to preferences revealed by the interactions. For example, in response to interactions such as selecting a song, repeating a song, turning up the volume, etc., the music preferences can be updated to indicate that user 202 likes that song. In another example, in response to user interactions such as skipping a song, turning down the volume, etc., the music preferences can be updated to indicate that the user dislikes that song. Profile data 212 can also be obtained from extrinsic sources 216 that can include various social networking sites, external data bases, and other sources of information available to the public or made available by the express or implied consent of user 202.

History data base 214 can store historical data H^{u} that memorializes interactions between user 202 with system 200 and more particularly portable media player 204 and data describing the user's situational context within the real world. In this way, profile data 212 and history data base 214 can be used together to represent associations between song preferences and factors describing the user's situation while in the real world. One such situational factor may be the user's current activity within the real world. For example, if a user frequently selects a particular song while playing a sport, the music preferences can be modified to store a positive association between the selected song and the activity of playing the sport. Another situational factor may be the user's current companions within the real world. For example, if the user always skips a certain song while in the company of a particular business associate, the music preferences can be modified to store a negative association between the song and the business associate. In another example, if a particular song was playing during a first meeting between the user and a casual acquaintance, the music preferences can be modified to store a mnemonic relationship between the song and the acquaintance. Thereafter, the song may be played when the user again encounters the acquaintance, thus serving as a reminder of the context of the first meeting between them.

Another situational factor can be the user's profile, meaning a general description of the primary user's intended activity or mode of interacting while in the real world. For example, a user engaged in business activities may use an “At Work” profile, and may prefer to listen to jazz while using that profile. Yet another situational factor may be the user's location within the real world. For example, a user may prefer to listen to quiet music while visiting a library, but may prefer to listen to fast-paced music while visiting a nightclub. In addition to personal information P^{u} and historical data H^{u}, the user data can include data corresponding to the reasons for listening (e.g., resting, concentrating, enhancing alertness, etc.) and can be stored in data base 210 as reason data R^{u}. Reasons for listening can be explicitly provided by user 202 or can be inferred by way of data analysis module 104.

Context data as input to playlist engine 100 can include environmental factors Eⁱ such as time of day, altitude, temperature, as well as physiologic data received from physiologic sensors Fᵢ, arranged to detect and record selected physiologic data of user 202. In some cases, the sensors Fᵢ can be incorporated in media player 204 or in garments (such as shoes 218 and shirt 220).

System 200 can include media analysis module 222 for performing the analysis of the songs or other media items stored in DML 208. Media analysis module 222 can assist in identifying various media metadata input to data collector module 102. In an alternative embodiment, when no analysis module is provided, any necessary media metadata can already be known (e.g., is stored on the computer-readable media of portable media device 204 provided by DML 208 as metadata associated with each song) or available to data collector module 102 via a network from a remote data store such as server side database(s) or a distributed network of databases. Media analysis module 222 has the ability to calculate audio content characteristics of a song such as tempo, brightness or belatedness. Any objective audio (or video, if appropriate) characteristic can be evaluated and a representative value determined by media analysis module 222. The results of the analysis are a set of values or other data that represent the content of a media object (e.g., the music of a song) broken down into a number of characteristics such as tempo, brightness, genre, artist, and so on. The analysis can be performed automatically either upon each detection of a new song stored in DML 208, or as each new song is rendered. User 202 may also be able to have input into the calculation of the various characteristics analyzed by the media analysis module 222. User 202 can check to see what tempo has been calculated automatically and manually adjust these parameters if they believe the computer has made an error. Media analysis module 222 can calculate these characteristics in the background or may alert user 202 of the calculation in order to obtain any input from same.

System 200 can generate personalized context aware playlist 108 that can be a function of all data provided to data collector module 102. The data provided to data collector module 102 can be static or dynamic. By static it is meant that a playlist can be provided for a particular context as requested by user 202. However, the playlist can nonetheless be dynamically updated when, and if, the specifics of the context changes as indicated by sensor data, location data, user provided data, and so on. For example, if user 202 starts off the day by deciding to take a jog, then user 202 can request a playlist consistent with a jogging context. However, if during the jog, sensors Fᵢ provide data to data collector module 102 indicating that the jogging context has changed to a running context situation, then the playlist can be updated dynamically (and without any intervention by user 202) to a playlist consistent with the running context.

In this way, playlist engine 100 can be configured to automatically generate playlists based on an actual or anticipated context. That is, playlist engine 100 can analyze the music preferences included in personal information P^{u} in order to generate a playlist that is adapted to the current situational context 202 within the real world, including the user's activity, profile, location, companions, and the like. In the case of a user that is currently playing a sport, playlist engine 100 can analyze the music preferences to determine whether the user has a positive association between any songs and the activity of the sport being played. If so, playlist engine 100 can generate a playlist that includes those songs. The generated playlist can then be provided to client application 224 and can be played to the user through media player 204. In one embodiment, playlist 108 can include a list(s) of song identifiers (e.g., song names). Client application 224 can be configured to retrieve audio content from DML 208 matching the song identifiers included in playlist 108. In another embodiment, playlist 108 can include audio content of songs, which may be played directly by client application 224. Such audio content may include, e.g., MP3 files, streaming audio, analog audio, or any other audio data format. Therefore, when user 202 is preparing to start an athletic activity, such as jogging, then sensors F₁ in shoes 218 can signal playlist engine 100 to provide a suitable playlist of songs suitable for jogging. In some cases, playlist engine 100 can select a song stored in DML 208 having attributes aligned with the desired context. For example, when shoes 218 signal playlist engine 100 that user 202 is preparing to take a jog, then playlist engine 100 can generate a new playlist consistent with the context of jogging by querying database 208 and identifying those songs having attributes associated with jogging.

Playlist engine 100 can also be configured to generate playlist 108 based on a mood or emotional state of user 202. More specifically, data collector module 102 can receive input data indicative of the mood or the emotional state of user 202. Such data can include, for example, an indication that user 202 has, or is about to meet, a personal acquaintance and if there is any previous mood state associated with that individual. Data collector 102 can then properly format and pass the user's mood data to data analysis module 104. Analysis module 104 can use a classification or regression model to estimate the mood of user 202. For example, using a classification model, analysis module 104 can use database 228 (described in more detail below) to compare user's mood data received from data collector module 102 to a plurality of mood associations consistent with data provided in the personal information P^{u}. Once the current mood of user 202 has been established, data analysis module 104 can update appropriate mood association data (database 228, for example) by associating the current mood of user 202 with current song preferences of user 202. The mood of user 202 can also be estimated by, for example, searching any communications from or to user 202 for keywords or phrases that have been predefined as indicating a particular mood. For example, assume that user 202 states “My friend and I had a fight, and now I am angry.” In this situation, data analysis module 104 can carry out a comparison of keywords “fight” and “angry” to predefined associations of keywords and moods, and thus to determine that the user's current mood is one of anger. Alternatively, the user's mood may be determined by other techniques. For example, the user's mood may be determined by measuring physical characteristics of the user that might indicate the user's mood (e.g., heart rate, blood pressure, blink rate, voice pitch and/or volume, etc.), by user interactions (e.g., virtual fighting, virtual gestures, etc.), or by a user setting or command intended to indicate mood.

Playlist engine 100 can be further configured to generate playlists for the purpose of trying to change the user's mood. That is, if the user's current mood does not match a target mood, playlist engine 100 can generate a playlist that includes songs intended to change the user's mood. The target mood may be a default setting or a user-configurable system setting. For example, assume user 202 has configured a system setting to specify a preference for a happy mood. Assume further that it has been determined that user 202 is currently in a sad mood. In this situation, playlist engine 100 can be configured to generate a playlist that includes songs predefined as likely to induce a happy mood. Alternatively, playlist engine 100 can be configured to randomly change the genre of songs included in a playlist, and to determine whether the user's mood has changed in response.

The link between a context and a playlist can be established by choosing a single preferred song referred to as seed track 230 that can be used to establish a playlist. By using a seed track 230 to set up the playlist, music listeners only have to select a song that they currently want to listen to, or that they prefer, in the given context-of-use. In one embodiment, seed track 230 can include metadata that can be updated to specifically identify a context provided by user 102. In this way, the selection process requires minimal cognitive effort on part of user 202 since people can select a song that is always, or almost always, chosen in a similar context-of-use. After receiving seed track 230, playlist engine 100 can present a playlist that includes seed track 230 and songs that are similar to seed track 230 that, taken together, have attributes consistent with a current context of user 202.

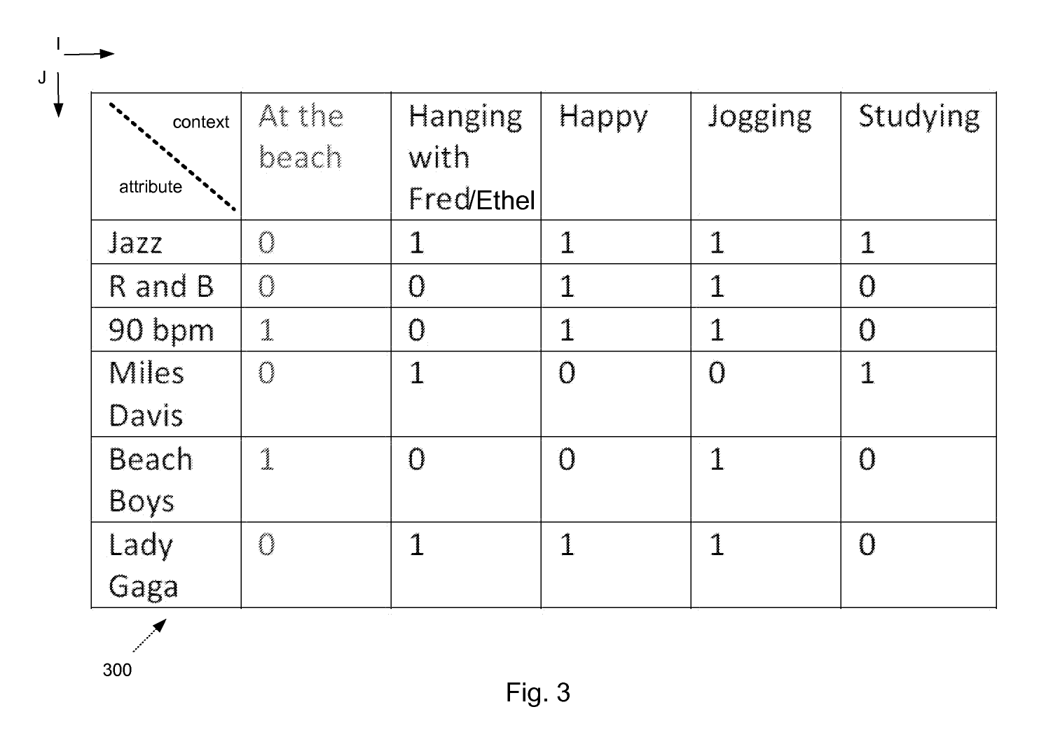

FIG. 3 shows representation of database 228 in the form of data array 300. Data array 300 can include at least columns I and rows J where each column designates a particular context and each row corresponds to a media item attribute (genre, beats per minute, etc.) for songs that have been determined to most highly correlate with that particular context. For example, column 1 can be associated with “at the beach”, column 2 with “hanging with Fred & Ethel”, column 3 with “Happy”, column 4 with “jogging” and so on. Each row J can be associated with a particular media item metric, or attribute. For example, when referring to music, rows J can be assigned the metrics of, for example, genre, tempo, artist, and so on. At the intersection of each row and column, a value indicating a degree of correlation between music attribute and the context can be found at the corresponding element of data array 300. The value of the degree of correlation that can be represented as weight, or weighting factor, that can range from about 0 and ±1, where 0 indicates little or no correlation, and ±1 indicating fully or almost fully correlated (either positive or negative).

Using the “at the beach” column (I=1) as an example, assume that either explicitly or implicitly, analysis module 104 has determined that user 202 is currently or is planning on being “at the beach” (context=“at the beach”). Once the context determination is complete, analysis module 104 can notify recommender module 106 of the result. Recommender module 106 can respond by querying data array 300 in order to determine appropriate music to be included in any playlist for “at the beach” using data encoded in column I=1.In this way, recommender module 106 can query DML 208 (more particularly media metadata Mᵢ) looking for music that aligns with the attribute profile corresponding to “at the beach” having a context filter C as shown in Eq. (1):

C={0, 0, 1, 0, 1, 0}. Eq (1)

By applying context filter C to media metadata Mᵢ associated with media items stored in DML 208, recommender module 106 can generate playlist 108 specifically for user 202 at the beach. In particular, playlist 108 can include songs from the musical group “Beach Boys” having a beat per minute of about 90 BPM. In some cases, it is possible to combine existing contexts of use to form a third, modified context. For example, if it is determined that user 202 is preparing to jog at the beach, then instead of creating a separate context of “jogging at the beach”, playlist engine 100 can essentially perform a logical “AND” operation between the attribute values for “at the beach” and “jogging” to provide a narrower list of possible songs for playlist consistent with the context of “jogging at the beach” or a logical “OR” for a more expansive list of possible songs.

In order to assure that only relevant media items are considered for inclusion in the user's context aware playlist, a relevance threshold can be set where only those media items having a relevance factor or weight above the threshold are considered for inclusion in the context aware playlist. On the other hand, in order to provide the user with as wide an experience as possible, a user profile can be developed that can be used to filter or otherwise process a preliminary playlist of media items derived from an online database. The filtering can eliminate those media items deemed less likely to be acceptable to the user for inclusion in the contextual aware playlist.

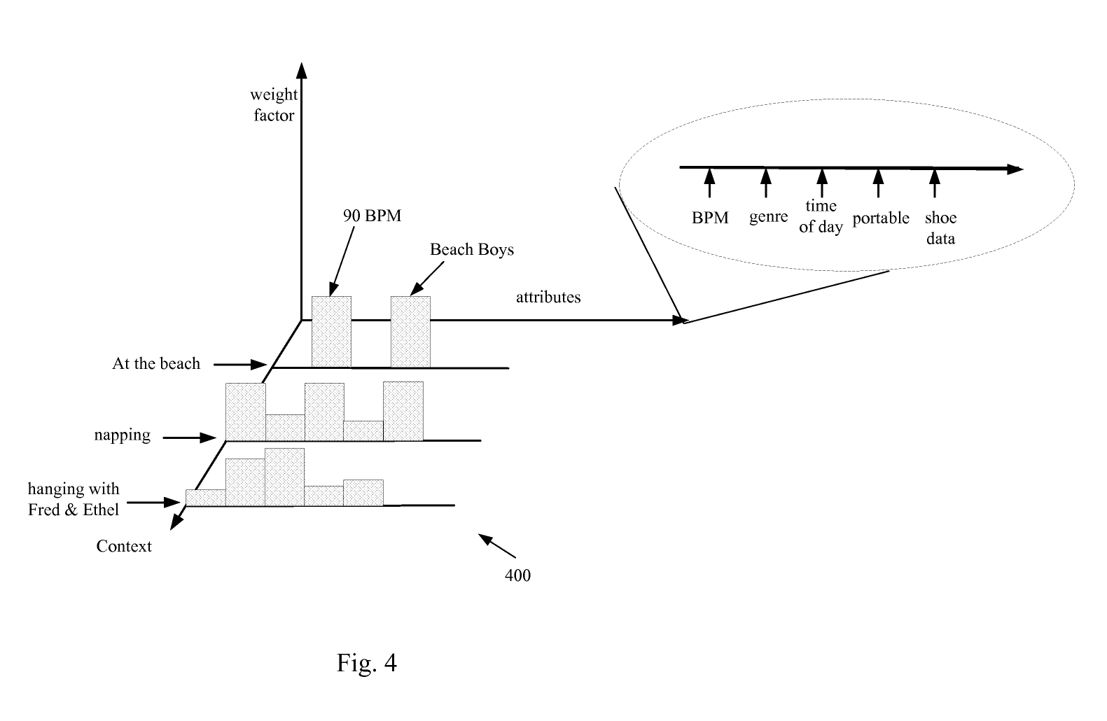

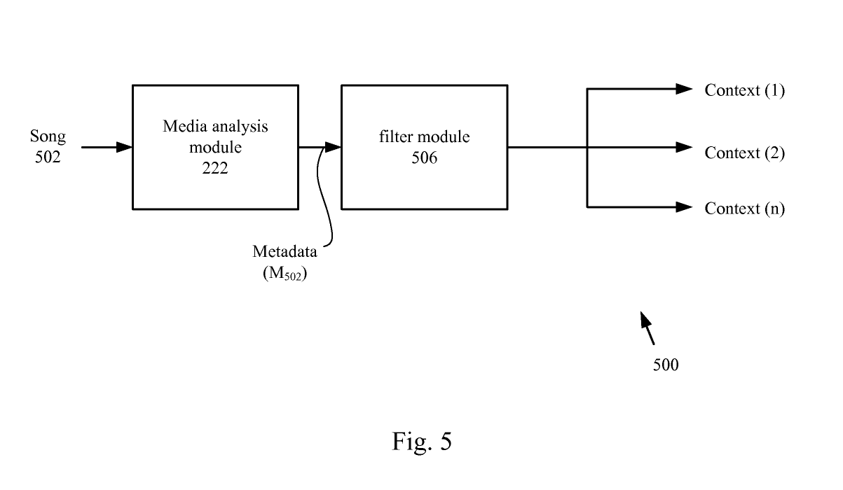

In addition to filtering a database for songs that match a particular context profile, a reverse filtering operation can also be performed in order to determine those context(s) of use for which a particular song is most appropriate. For example, FIG. 4 shows a three dimensional representation of “context space” 400 in accordance with the described embodiments. As shown, context space 400 can be represented as three orthogonal axes, Attributes, Weight, and Context (i.e., three dimensional representation data array 300). Therefore, a song having an unassigned (or at least unknown) context for a particular user can nonetheless be assigned a context(s) of use using context space 400 as a filter. For example, as shown in FIG. 5, song 502 having an unclassified context with regards to user 202 can be analyzed by media analysis module 222 for associated metadata 504 that can be represented by metadata vector M={metricsᵢ}. Metadata 504 (or more specifically metadata vector M) can then be “reverse” filtered by filter module 506 as part of media analysis module 104 by comparing to context space 400 where a context, or contexts, can be assigned to song 502 based upon how closely metadata 504 matches each context representation. For example, if song 502 has an associate metadata vector M₅₀₂ {0 0 1 1 1 0}, then there is a relatively good match between song 502 and “at the beach”. However, further analysis may be required since it may be that song 502 is actually well suited for more than one context or a combination of contexts.

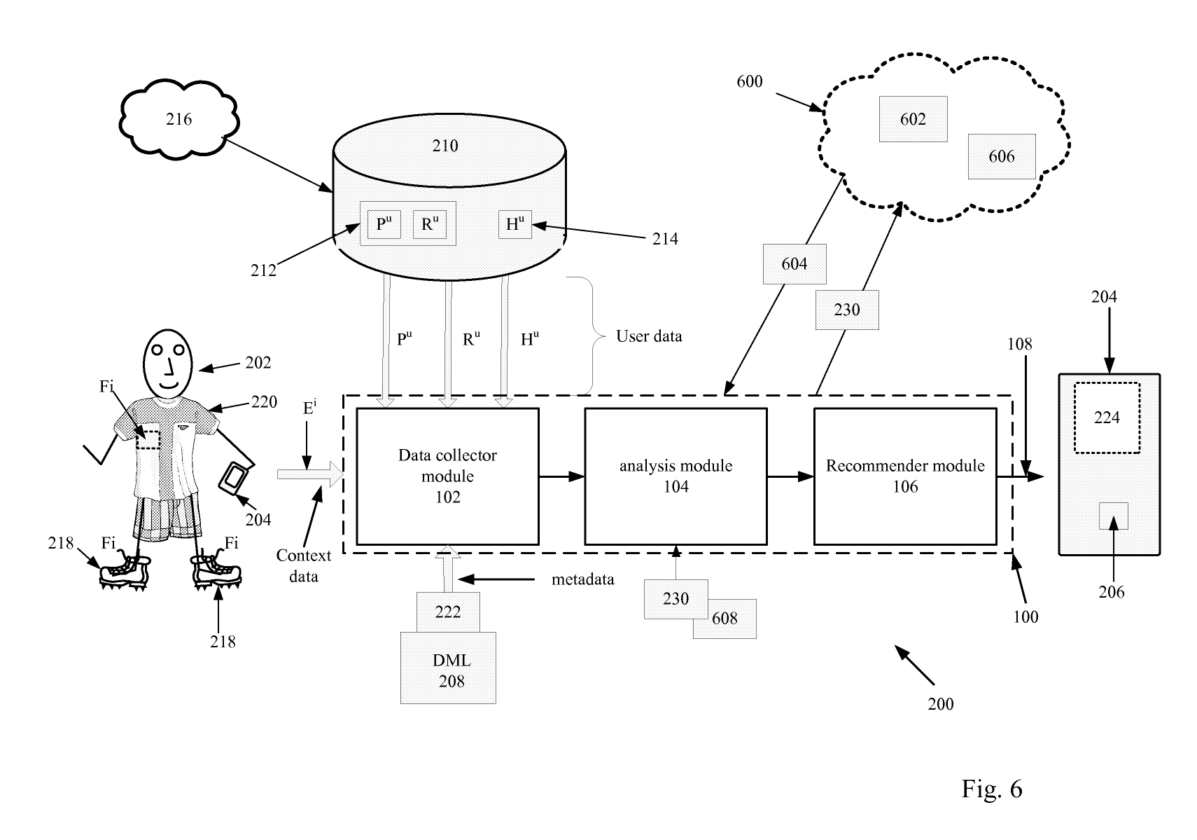

FIG. 6 shows system 200 is in communication with remote system (also referred to as cloud computing system) 600. Playlist engine 100 can provide seed track 230 to server-based playlist application 602. Server playlist application 602 can generate content similar to preliminary playlist 604 using aggregated user similarity data 606 along the lines described in U.S. patent application “SYSTEM AND METHOD FOR PLAYLIST GENERATION BASED ON SIMILARITY DATA” by Gates et al. One advantage to using server playlist application 602 is that the number of songs available for consideration for inclusion in playlist 108 is vastly greater than that available at DML 208. In this way, the ability to provide more varied playlists as well as playlists that are more likely to be accepted by user 202 in the particular context is greatly enhanced. However, since it is contemplated that server playlist application 602 does not comprehend the contextual nature of the data resident at database 210 nor has access to sensor data, any playlists provided by server playlist application 602 must be further processed by playlist engine 100 in order to provide an acceptable context aware playlist.

Preliminary playlist 604 can be further processed locally by playlist engine 100 in order to provide playlist 108 that is consistent with the desired context. Accordingly, seed track 230 can be presented to playlist engine 100 having associated context indicator 608. Context indicator 608 can be used by analysis module 104 to identify a particular context for which playlist 108 will be used. In some cases, context indicator 608 can be manually provided by user 202 by way of, for example, a graphical user interface presented by portable media player 204. In other cases, however, context indicator 608 can be automatically associated with seed track 230 based on processing carried out by analysis module 104 in portable media player 204 using data provided from database 110, sensors Fᵢ and so on. For example, if the desired context is determined to be “at the beach”, then context indicator 608 can be assigned a value consistent with column value I=1 matching the context “at the beach” with respect to data array 300 shown above. In any case, seed track 230 can be forwarded to cloud network 600 for processing. It should be noted, however, that since application 602 is typically not configured to identify particular contexts of use, there is no need to send context indicator 608 to application 602. Even if context indicator 608 accompanies seed track 230, in all likelihood, application 602 will ignore context indicator 608.

In response to receiving seed track 230, application 602 can provide preliminary playlist 604. In most cases, preliminary playlist 604 will include several songs chosen based upon a collaborative correlation type process whereby the properties of a large aggregation of songs is used to predict those songs most likely to be found acceptable for inclusion in a playlist. However, since there is neither consideration of personal preferences of user 202 nor the context in which the playlist is used in the selection process, preliminary playlist 604 is post processed by analysis module 104 to provide input to recommender module 106. The further processing is directed at identifying those songs in preliminary playlist 604 that align with the context identified in context indicator 608. This identification can be carried out along the lines of the filtering operation described above; in particular, the characteristics of the context associated with context indicator 608 can be used to identify suitable candidates for inclusion in playlist 108. In some embodiments, a determination can be made if there is sufficient number of candidate songs identified. If the determination indicates that there are not a sufficient number of identified songs, then seed track 230 (or another one of the identified songs found to be acceptable) can be forwarded to application 602 in order to provide another preliminary playlist for analysis. This process can continue until there are a sufficient number of songs available for inclusion in playlist 108.

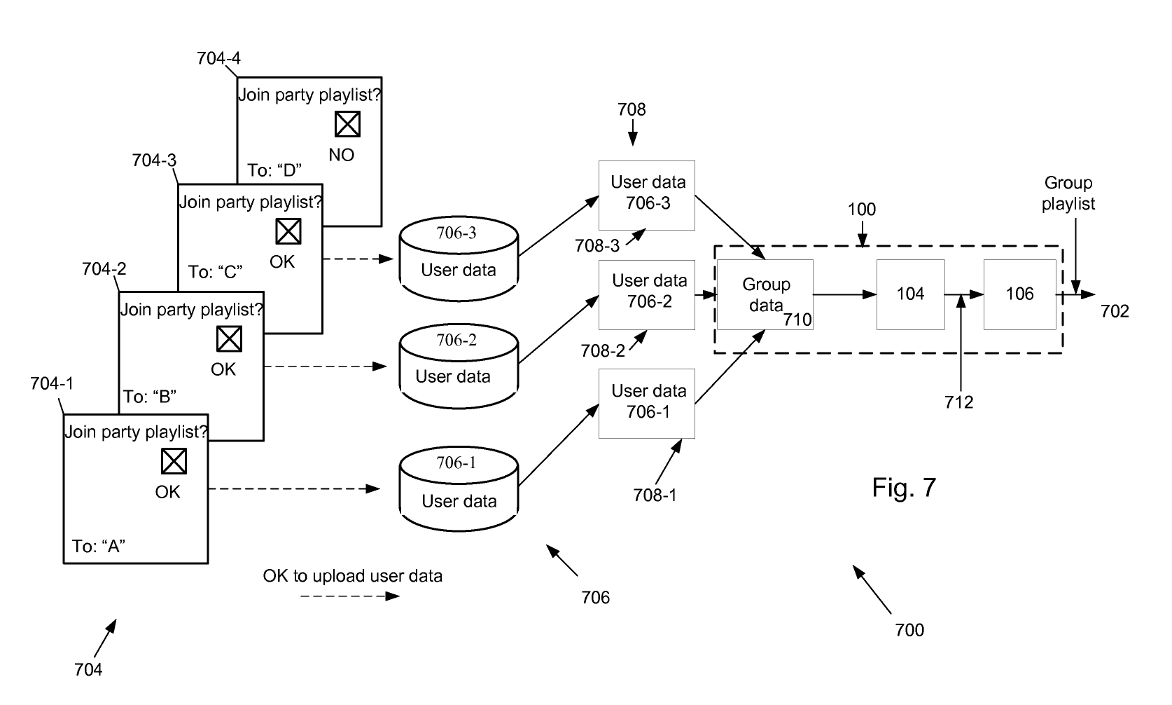

In some cases, it may be advantageous to include user data in cloud computing system 600 for more than one user. In this way, a group playlist can be generated that reflects more than one user. This can be particularly useful in those cases, such as a party or other social gathering, where a number of people are scheduled to congregate and a group playlist is desired. FIG. 7 shows arrangement 700 whereby playlist engine 100 can provide group playlist 702 suitable for a social gathering such as a party. Assume that a party giver has sent out a number of party invitations at least some of which are electronic invitations 704. As part of the acceptance process, each invitee that has received one of electronic invitations 704 is given the choice to opt into taking part in the group playlist 702. Assume further that at least some (704-1 through 704-3) of the invitees have opted in by affirmatively checking an input box with “OK” whereas others (704-4) have decided to not take part. In one embodiment, the acceptance (by inputting of OK or otherwise acknowledging acceptance) can allow at least some user data 706 associated with each accepting invitee to be uploaded to corresponding user data buffers 708. More specifically, user data 706-1 associated with an invitee 704-1 can be uploaded to user data buffer 708-1, user data 706-2 associated with invitee 704-2 can be uploaded to user data buffer 708-2, and so on. Once all user data has been successfully loaded and confirmed for authenticity, user data 706-1 through 706-3 can be loaded to group data buffer 710.

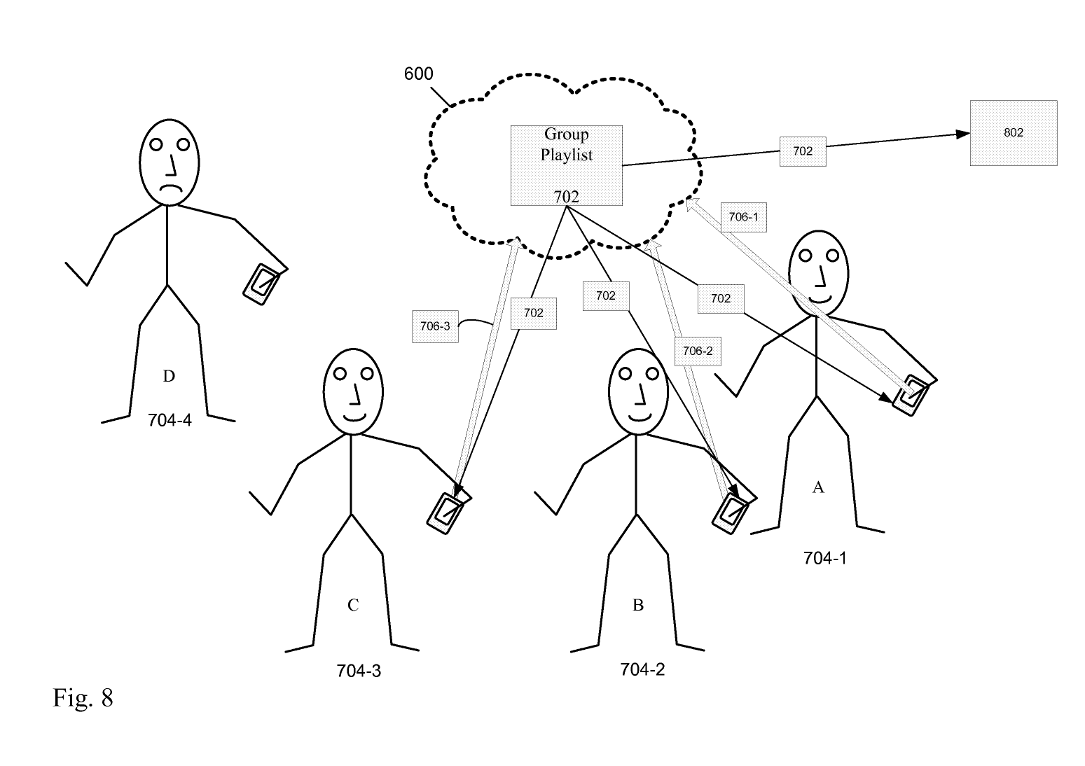

Once group data buffer 710 has been loaded with user data 706-1 through 706-3, playlist engine 100 (or more precisely, analysis module 104 can generate group profile 712. Group profile 712 can then be used by recommender module 106 to provide group playlist 702. As shown in FIG. 8, group playlist 702 can then be forwarded to each user 704-1 through 704-3 by way of their respective portable media players 104-1 through 104-3 for rendering. Alternatively, group playlist 702 can be forwarded to a central media player (or server) 802 for broadcast play of songs and music corresponding to information provided by group playlist 702. It should be noted that in some cases, only those individual users (704-1 through 704-3 in this example) have received group playlist 702 whereas user 704-4 has not since this particular user originally opted out of participating in the group playlist generation. Of course, this is only optional as system 700 can be configured to distribute playlist 702 to anyone attending the group activity.

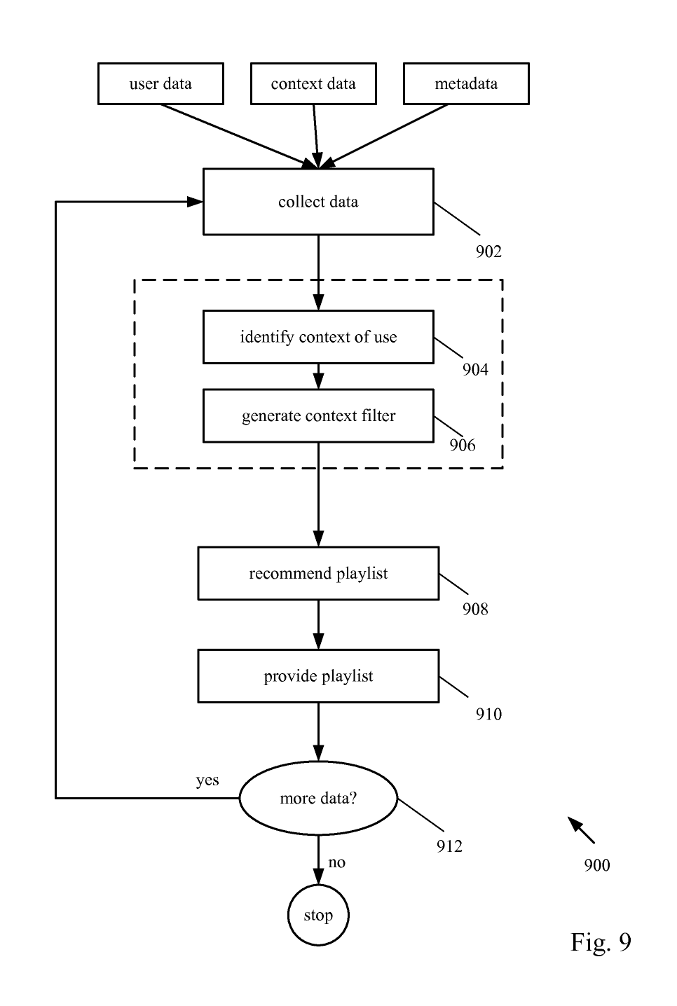

FIG. 9 graphically illustrates a flowchart detailing process 900 for providing a personalized context aware playlist in accordance with the embodiments. Process 900 can begin at 902 by collecting data that can include user data, context data, and media metadata. In the described embodiment, user data can include user preferences in music, sport, art as well as, physical attributes such as age, gender, and demographic data as well as any other data deemed appropriate for aiding in characterizing the user. Context data can be collected to anchor the user's preferences to a particular context and can include environmental factors Eⁱ such as time of day, altitude, temperature as well as physiologic data received from physiologic sensors Fᵢ arranged to detect and record selected physiologic data of the user. It should be noted that context data can be dynamic in nature in that the context data received can change over the course of time indicating the possibility of a concomitant change in the context. For example, physiologic data can include heart and breathing rate that can be associated with jogging in one time period but can change during another time period to indicate that the jogging context has changed to a running context. This change in context can then be reflected in the change in the context aware playlist. Metadata can contain information such as textual titles of the genres, artists, albums, tracks, lyrics, etc., as well as acoustical features of timbre, rhythm, harmony, and melody. Therefore, the metadata can be used to associate different pieces of music, for example, with each other, and to help alleviate any lack of the rating and listening data.

The collected data can be forwarded for data analysis that can include determining a context at 904. The context can be determined using any number of classification or regression models. For example, user physiologic data (e.g., fast heart rate), location data (Aspen, Colo.), and altitude data (above 8000 ft) can be used to estimate that a current context is related to a high altitude physical activity such as skiing. Based upon the current context, a context filter can be developed at 906. The context filter can include a characterization of those song attributes predicted to be most likely to be found acceptable to the user in the intended context. The characterization can include those weighted attributes of media items, such as songs, corresponding to the context. The weighted attributes can then be compared against metadata that can provide some estimation of the likelihood that a user will find a particular song acceptable for the intended context. The context filter can be used at 908 to recommend songs to be included in the context aware playlist by filtering songs included in a database of songs to determine those most likely to be found acceptable to the user during the intended context. The context aware playlist is then provided to the user at 910. In order to assure that any changes in the context are reflected in the current context aware playlist, at 912, a determination is made whether or not there is updated data. By updated data it is meant any changes to any of the user data, context data, or metadata that can affect the contents of the context aware playlist. For example, if it is determined that there is updated data, then control is passed back to 902 for collection of the updated data and ultimately updating, if necessary, of the current context aware playlist to an updated context aware playlist to be provided to the user. If, however, there is no updated data, then process 900 ends.

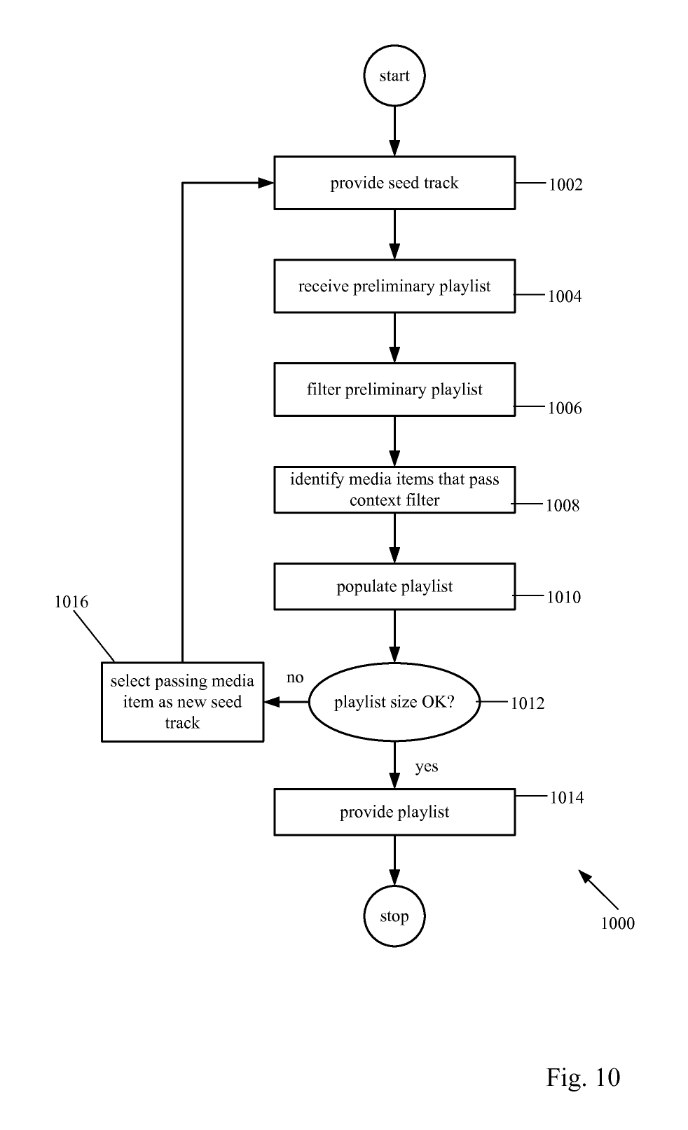

FIG. 10 graphically illustrates a flowchart detailing process 1000 for generating a context aware playlist in accordance with the described embodiments. Process 1000 is well suited for cloud computing applications executed on a server computer, or a distributed network of computers. Accordingly, process 1000 can begin 1002 by providing a seed track. The seed track can be a media item selected by a user having characteristics aligned with a desired context. In the described embodiment, the seed track can be processed by a playlist engine that does not comprehend the contextual nature of the seed track and will respond by generating a preliminary playlist that is not generally aligned with the desired context. Therefore, at 1004 the preliminary playlist is received and further processed at 1006 by context filtering the preliminary playlist. By context filtering it is meant that those constituent parts (i.e., songs, music) of the preliminary playlist having characteristics aligned with those used to characterize the desired context are identified. The identification process can be carried out by, for example, comparing metrics of each of the songs in the preliminary playlist with a context profile characterizing the desired context. Therefore, only those media items identified at 1008 as passing the context filtering are used to populate the context aware playlist at 1010.

At 1012, a determination is made whether or not a sufficient number of media items have been identified to populate the playlist. If the determination is in the affirmative, then the playlist is provided at 1014. Otherwise, an updated seed track is selected at 1016 and control is passed back to 1002. In the described embodiment, the updated seed track can take the form of one of the media items identified as having passed the context filtering operation. In this way, a different set of media items can be expected to populate the updated preliminary playlist thereby reducing the possibility of receiving similar playlists from previously received playlists.

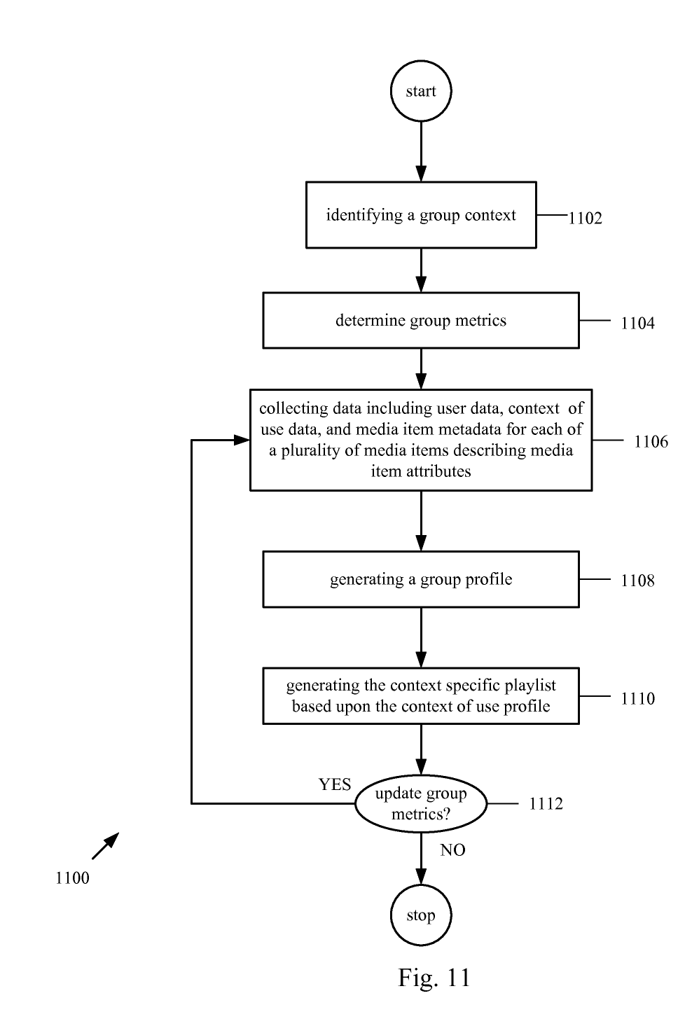

FIG. 11 shows a flowchart detailing process 1100 for providing a context aware group playlist in accordance with the described embodiments. Process 1100 can be carried out as described in FIG. 11 by identifying at 1102 a specific context for which the group playlist of media items is to be used. For example, the context can be any gathering of people for whatever purpose such as would be found at a party, nightclub, rave, and so on. At 1104, data used to define the group as a whole (referred to as group metrics) is monitored. In the described embodiment, the monitoring can occur in real time almost continuously, or periodically at certain (or even random) intervals. Group metrics can be any data associated with the group of users participating in the group activity. In some cases, the participating members can number less than of all those people attending a particular group activity as it is contemplated that some individuals may not wish to participate. The group metrics can also take into account the dynamics of the group in that the number of participating members can change in real time during the group activity (individuals entering or leaving the group). In this way, the group is monitored for any objective changes that can affect the contents of the context aware group playlist. Next at 1106, user data is collected for each participating member of the group associated with the identified context. Next at 1108, a group profile is developed based upon the collected user data and the identified context, the group profile characterizing the participating group members as a whole. The group profile can be generated based upon the individual user data provided by each of the participating members of the group. The individual user data can be obtained from many sources not the least of which include personal data provided by portable media players in communication with a central server computer, personal Internet sites, and so on. The group profile can be developed by, for example, using similarity analysis that identifies those attributes common to all, or at least a specified portion, of the individual users. For example, if the totality of the individual user data indicates that “Barry Manilow” is a favored artist amongst, in one case, a majority of the individual users, then an attribute associated with “Barry Manilow” can be more heavily weighted than an attribute associated with “Lady Gaga” having a lower incidence of favorability. In this way, the group profile can be used to identify those media items (such as songs) for inclusion in the group playlist that have a high likelihood that the group finds acceptable. The group profile can be used to compare the attributes found to most likely characterize songs that the group will find acceptable from a data base of music items. In particular, the group profile can be used to filter (i.e., identify) those songs in the data base of songs most closely matched with the attributes delineated by the group profile resulting in a group playlist being provided at 1110. At 1112, a determination is made whether or not the group metrics have updated, by which it is meant that any of the constituent data that goes to form the group metric has changed. Such changes can occur when, for example, an individual leaves or enters the group activity. If the group metric has not changed, then process 1100 ends, otherwise, control is passed to 1102 for additional processing and ultimately an updating, if necessary, of the group profile at 1102 and the context aware playlist at 1110.

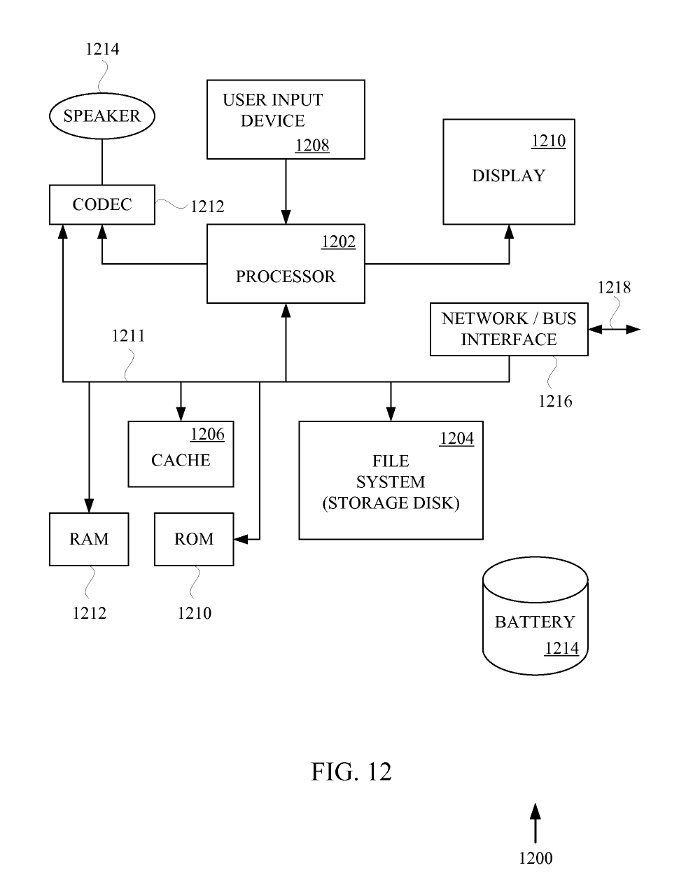

FIG. 12 is a block diagram of a media player 1200 suitable for use with the invention. The media player 1200 illustrates circuitry of a representative portable media device. The media player 1200 includes a processor 1202 that pertains to a microprocessor or controller for controlling the overall operation of the media player 1200. The media player 1200 stores media data pertaining to media items in a file system 1204 and a cache 1206. The file system 1204 is, typically, a storage disk or a plurality of disks. The file system 1204 typically provides high capacity storage capability for the media player 1200. However, since the access time to the file system 1204 is relatively slow, the media player 1200 can also include a cache 1206. The cache 1206 is, for example, Random-Access Memory (RAM) provided by semiconductor memory. The relative access time to the cache 1206 is substantially shorter than for the file system 1204. However, the cache 1206 does not have the large storage capacity of the file system 1204. Further, the file system 1204, when active, consumes more power than does the cache 1206. The power consumption is often a concern when the media player 1200 is a portable media player that is powered by a battery (not shown). The media player 1200 also includes a RAM 1020 and a Read-Only Memory (ROM) 1022. The ROM 1022 can store programs, utilities or processes to be executed in a non-volatile manner. The RAM 1020 provides volatile data storage, such as for the cache 1206.

The media player 1200 also includes a user input device 1208 that allows a user of the media player 1200 to interact with the media player 1200. For example, the user input device 1208 can take a variety of forms, such as a button, keypad, dial, etc. Still further, the media player 1200 includes a display 1210 (screen display) that can be controlled by the processor 1202 to display information to the user. A data bus 1211 can facilitate data transfer between at least the file system 1204, the cache 1206, the processor 1202, and the CODEC 1212.

In one embodiment, the media player 1200 serves to store a plurality of media items (e.g., songs, podcasts, etc.) in the file system 1204. When a user desires to have the media player play a particular media item, a list of available media items is displayed on the display 1210. Then, using the user input device 1208, a user can select one of the available media items. The processor 1202, upon receiving a selection of a particular media item, supplies the media data (e.g., audio file) for the particular media item to a coder/decoder (CODEC) 1212. The CODEC 1212 then produces analog output signals for a speaker 1214. The speaker 1214 can be a speaker internal to the media player 1200 or external to the media player 1200. For example, headphones or earphones that connect to the media player 1200 would be considered an external speaker.

The media player 1200 also includes a bus interface 1216 that couples to a data link 1218. The data link 1218 allows the media player 1200 to couple to a host device (e.g., host computer or power source). The data link 1218 can also provide power to the media player 1200.

The media player 1200 also includes a network/bus interface 1216 that couples to a data link 1218. The data link 1218 allows the media player 1200 to couple to a host computer or to accessory devices. The data link 1218 can be provided over a wired connection or a wireless connection. In the case of a wireless connection, the network/bus interface 1216 can include a wireless transceiver. The media items (media assets) can pertain to one or more different types of media content. In one embodiment, the media items are audio tracks (e.g., songs, audio books, and podcasts). In another embodiment, the media items are images (e.g., photos). However, in other embodiments, the media items can be any combination of audio, graphical or video content.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a computer readable medium. The computer readable medium is defined as any data storage device that can store data which can thereafter be read by a computer system. Examples of the computer readable medium include read-only memory, random-access memory, CD-ROMs, DVDs, magnetic tape, and optical data storage devices. The computer readable medium can also be distributed over network-coupled computer systems so that the computer readable code is stored and executed in a distributed fashion.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not intended to be exhaustive or to limit the embodiments to the precise forms disclosed. It will be apparent to one of ordinary skill in the art that many modifications and variations are possible in view of the above teachings.

The embodiments were chosen and described in order to best explain the underlying principles and concepts and practical applications, to thereby enable others skilled in the art to best utilize the various embodiments with various modifications as are suited to the particular use contemplated. It is intended that the scope of the embodiments be defined by the following claims and their equivalents.

What is claimed is:

1. A real time method of automatically providing a context aware playlist of media items, comprising:
collecting data, the data including user data, context data, and media item metadata for each of a plurality of media items, the media item metadata describing media item attributes;
analyzing the data, the analyzing comprising:
identifying a context;
generating a context profile in accordance with the user data and the context data, the context profile comprising a plurality of weighted media item attributes;
generating the context aware playlist using the context profile; and
providing the context aware playlist.

2. The method as recited in claim 1, wherein the generating the context aware playlist using the context profile comprises:
comparing the plurality of weighted media item attributes and the media item metadata for each of the plurality of media items;
identifying those of the plurality of media items for inclusion in the context specific playlist based on the comparing; and
updating metadata of the identified media items to indicate inclusion in the context aware playlist.

3. The method as recited in claim 1, wherein the user data includes at least user media item preference data and wherein the context data includes at least user physiological data.

4. The method as recited in claim 1, wherein when the media item is a music item, then the media item attributes include at least genre, beats per minute, and artist.

5. The method as recited in claim 1, further comprising:
monitoring the collected data;
updating the identified context based upon the monitored collected data; and
updating the context aware playlist based upon the updated context.

6. The method as recited in claim 1, wherein at least some of the plurality of media items are stored in a cloud computing system.

7. The method as recited in claim 6, wherein the cloud computing system provides a preliminary playlist of media items, wherein the preliminary playlist is not context aware.

8. The method as recited in claim 7, comprising:
filtering the preliminary playlist using the context profile;
identifying the media items that pass the filtering; and
providing the context aware playlist using only the identified passing media items.

9. A method of providing a context aware group playlist of media items, comprising:
identifying a group context;
determining group metrics comprising receiving a user data file from each of at least two members of the group identified as active participants;
collecting user data at least from the active participants;
forming a group profile by collating the collected user data files;
generating a group playlist of media items using the group profile; and
distributing the group playlist of media items to each of the at least two members of the group.

10. The method as recited in claim 9, wherein the determining the group profile comprises:
retrieving user preferences for each of the at least two members of the group;
comparing the retrieved user preferences;
identifying a pre-determined number of user preferences common to the at least two members of the group; and
generating the group profile using at least some of the identified user preferences.

11. The method as recited in claim 9, wherein the context aware group playlist of media items is wirelessly distributed to the substantially all members of the group.

12. The method as recited in claim 9, further comprising:
when at least one of the at least two members of the group from which user data was received is no longer participating in the group activity, then
updating the group profile based upon the remaining participating members of the group remaining active in the group activity;
updating the group playlist; and
distributing the updated group playlist.

13. The method as recited in claim 9, further comprising:
when the plurality of users in attendance of the group function increases,
updating the group profile based upon the increased plurality of users;
updating the group playlist; and
distributing the updated group playlist.

14. A portable media player in communication with a host device, comprising:
an interface, the interface facilitating a communication channel between the portable media player and the host device; and
a processor, the processor arranged to receive a group playlist identifying media items for rendering in an order and manner specified by the group playlist, wherein the group playlist is generated by the host device by:
identifying a group context for which the media items identified by the group playlist is to be used,
collecting data, the data including user data, context of use data, and media item metadata for each of a plurality of media items, the media item metadata describing media item attributes, wherein the media items identified by the group playlist is a proper subset of the plurality of media items available to the host device;
analyzing the collected data to generate a group profile corresponding to the group context, the group profile comprising a plurality of weighted media item attributes, and
using the group profile to provide the group playlist.

15. The portable media player as recited in claim 14, further comprising:
at least one environmental sensor, the sensor arranged to detect an environmental input event; and
at least one physiological sensor, the physiological sensor arranged to detect a physiological input event.

16. The portable media player as recited in claim 15, wherein the processor monitors the at least one environmental sensor and the at least one physiological sensor, and when the monitoring indicates that there is a change in the group context, then the processor sends a request to the host device to update the group playlist.

17. The portable media player as recited in claim 16, wherein the processor receives the updated group profile and updates the group playlist, the updated group playlist identifying an updated list of media items for rendering by the processor in the order and manner prescribed by the updated group playlist.

18. A non-transitory computer readable medium for encoding computer software executed by a processor for providing a context aware playlist of media items, comprising:
computer code for identifying a context for which the playlist of media items is to be used;
computer code for collecting data, the data including user data, context data, and media item metadata for each of a plurality of media items, the media item metadata describing media item attributes;
computer code for generating a context profile, the context profile comprising a plurality of weighted media item attributes; and
computer code for using the context profile to provide the context aware playlist.

19. The computer readable medium as recited in claim 18, wherein using the context profile to provide the context aware playlist comprises:
computer code for comparing the plurality of weighted media item attributes and the media item metadata for each of the plurality of media items;
computer code for identifying those of the plurality of media items for inclusion in the context specific playlist based on the comparing, wherein the identified media items is a proper subset of the plurality of media items; and
computer code for updating metadata of the identified media items to indicate inclusion in the context aware playlist.

20. The computer readable medium as recited in claim 18, wherein the user data includes at least user media item preference data and wherein the context data includes at least user physiological data.

21. The computer readable medium as recited in claim 18, wherein when the media item is a music item, then the media item attributes include at least genre, beats per minute, and artist.

22. The computer readable medium as recited in claim 18, further comprising:
monitoring the collected user data;
updating the identified context based upon the monitored collected user data; and
updating the context aware playlist based upon the updated context.
